(19) United States
(12) Patent Application Publication
(10) Pub. No.: US 2011/0113597 A1
(43) Pub. Date: May 19, 2011

(54) QUICK-ACTION FASTENING ELEMENT

(75) Inventor: Sven Budde, Luebbecke (DE)

(73) Assignee: PAUL HETTICH GMBH & CO. KG, Kirchlengern (DE)

(21) Appl. No.: 13/054,099

(22) PCT Filed: Jul. 15, 2009
(86) PCT No.: PCT/EP2009/059055

§ 371 Date: Jan. 14, 2011

(30) Foreign Application Priority Data
Jul. 30, 2008 (DE) 20 2008 010 188.3

(51) Int. Cl. F16B 2/06

(52) U.S. Cl. 24/457

(57) ABSTRACT

The invention discloses a quick-action fastening element (70) for fastening a rail (62) of a pull-out guide (60) on a horizontal rod (2) of a grid-like side part (4), in particular for baking ovens, wherein the rod (2) has an end portion (5) which is bent away at an angle to a longitudinal direction and the quick-action fastening element (70) has a first clip (71), which at least partially engages around a portion of the rod (2) arranged in the longitudinal direction, and a second clip (76) which at least partially engages around the bent-away end portion (5), wherein a latching element (74) which engages behind the rod (2) and prevents the quick-action fastening element (70) from being pulled out in a direction parallel to the bent-away end portion (5) is provided, wherein the latching element (74) is in the form of a rigid elevation formed integrally with the first or second clip (71, 76).

The present invention relates to a quick-action fastening element for fastening a rail of a pullout guide to a horizontal rod of a latticed side part, in particular for ovens, according to the preamble of claim 1.

DE 20 2006 002 251 discloses a quick-action fastening device for fixing a rail of a pullout guide on a latticed side part, clamp-like holding sections being provided, which at least partially enclose a rod. Furthermore, a locking element is provided for fixing the quick-action fastening device, which engages behind a rod, so that the guide rail can be fixed on the rod. The locking element can be bent manually for removal, in order to remove the quick-action fastening device if needed. This can be performed manually by the user, which has the disadvantage that incorrect actuation is also possible. In addition, a risk of injury exists due to the angular locking element.

DE 20 2005 020 458 also discloses a quick-action fastening element for fixing a rail of a pullout guide on a strut of a side part, locking occurring on the latticed side part. The quick-action fastening element comprises locking means, which have a spring tongue, which can be bent manually by the user. Problems also result here when the user does not correctly handle the locking elements.

It is therefore the object of the present invention to provide a quick-action fastening element which provides secure fastening on a strut of a side part and is extensively protected against incorrect operations.

This object is achieved by a quick-action fastening element having the features of claim 1.

According to the invention, the quick-action fastening element comprises a locking element, which is formed as a rigid protrusion, which is integrally formed with the first or second clamp. This prevents the locking element from being able to be pivoted smoothly, which could induce the user to manually grasp the locking element, in order to perform removal or installation. This is to be avoided since the locking element is detachable upon use of a tool, but unintentional manual actuation is reliably prevented by a rigid implementation.

According to a preferred embodiment of the invention, the protrusion of the locking element is formed on a strip-shaped section, both sides of the strip-shaped section being connected to the clamps. A freestanding end section which is smoothly pivotable is thus lacking. Rather, the elasticity of the material must be used to move the protrusion during the engagement of the quick-action fastening element. The forces for moving the strip-shaped locking element are multiple times greater than the forces in the case of the freely pivotable end section of a previously known locking element, however.

According to a further embodiment of the invention, the locking element is spaced apart from the remaining part of the clamp via a recess enclosed on all sides by the material of the clamp. A strip-shaped contour is thus achieved, which is implemented as elastic per se, but comparatively rigid. In order to lengthen the web-shaped attachment of the locking element, the recess preferably has a U-shaped contour, so that an L-shaped web profile is provided as a pivotable lever.

The protrusion of the locking element preferably extends up to a middle area of the rod, i.e., approximately up to the height of a central longitudinal axis of the rod. In this area, the rod has the greatest width in the case of a circular contour, so that an essentially formfitting receptacle can be implemented on the quick-action fastening element.

According to a further embodiment of the invention, the protrusion of the locking element extends perpendicularly to the longitudinal direction of the rod over the entire width of the locking element and is situated diagonally to the horizontal. The protrusion of the locking element can be largest adjacent to the rod, so that when the quick-action fastening element is pushed on, a starting bevel is provided, which allows easy installation.

The locking element is preferably shaped on a wall section of the first clamp, so that withdrawal of the quick-action fastening element in a direction parallel to the bent-over end section of the rod is prevented.

The invention is explained in greater detail hereafter on the basis of an exemplary embodiment with reference to the appended drawings. In the figures:

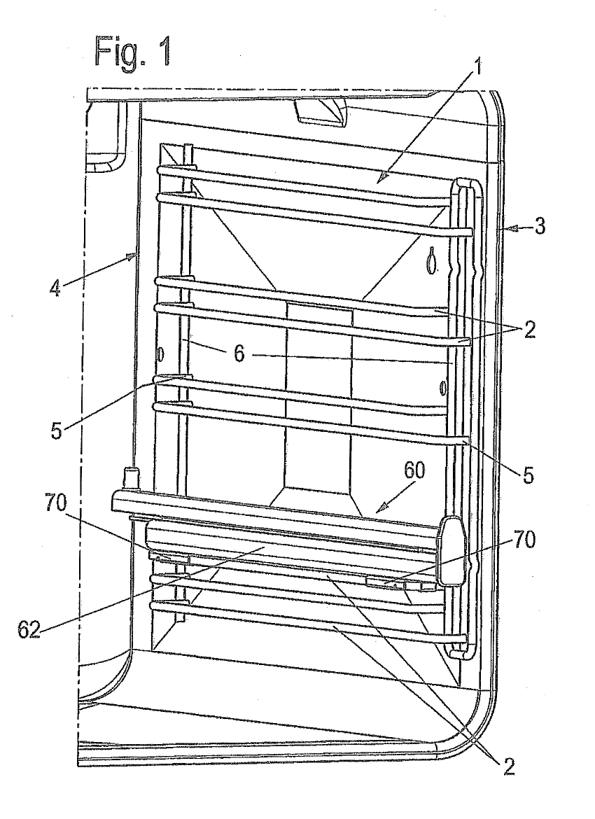

FIG. 1 shows a perspective view of an interior of a household appliance having quick-action fastening element in the installed state;

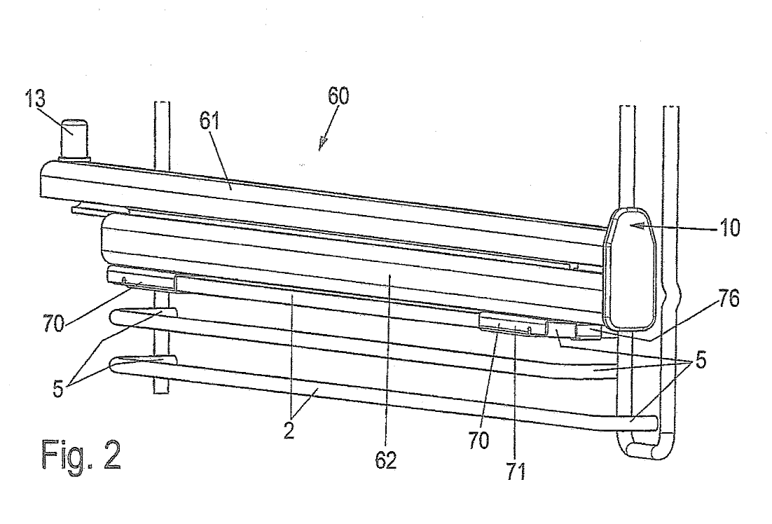

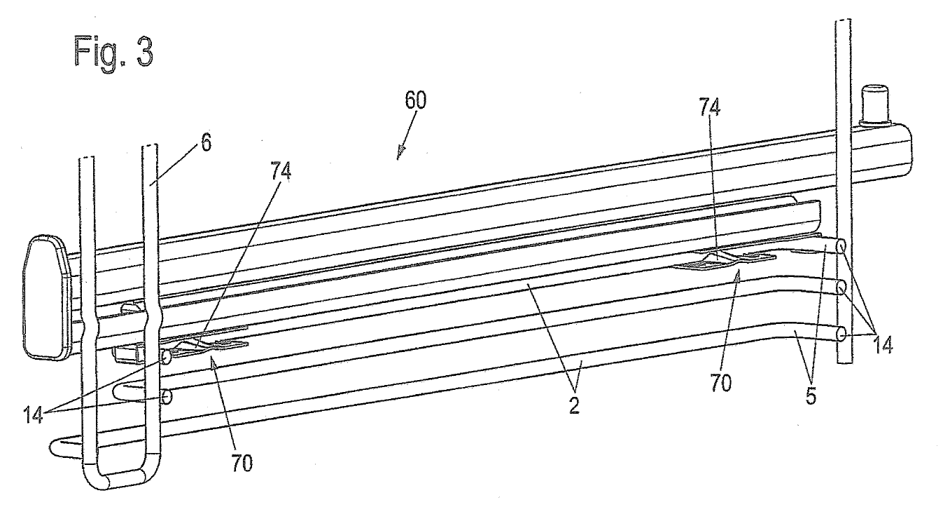

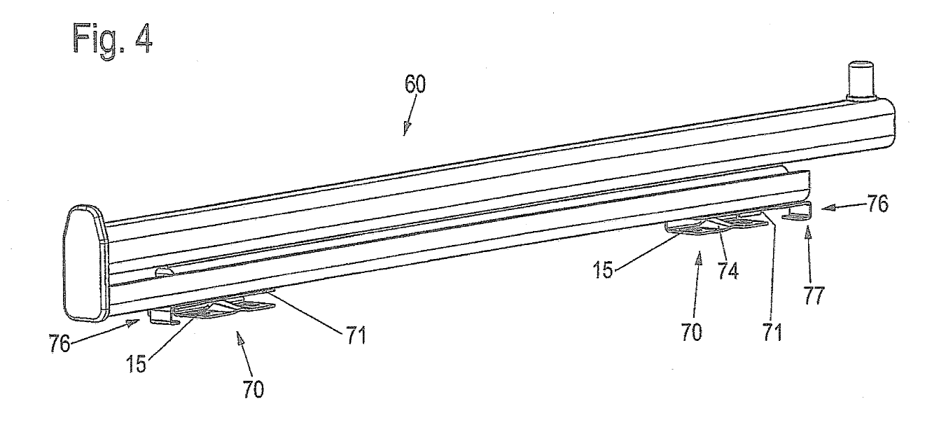

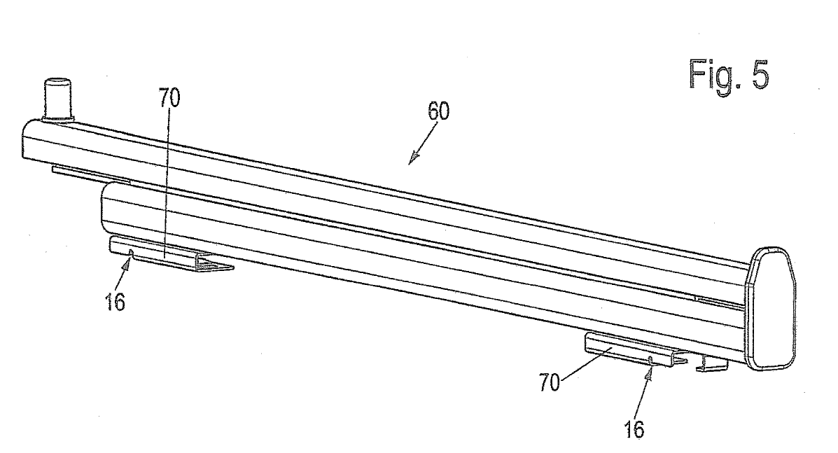

FIGS. 2 to 5 show multiple perspective views of a quick-action fastening element installed on a rail of a pullout guide, and

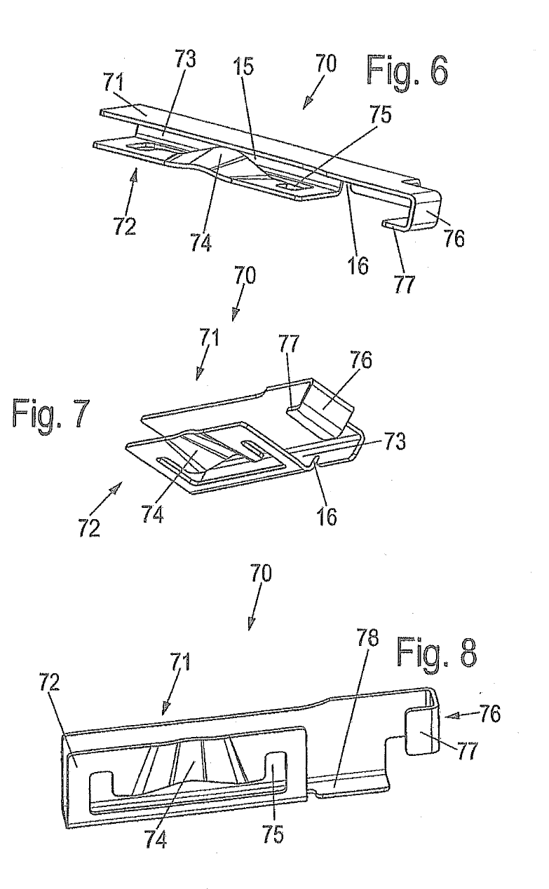

FIGS. 6 to 8 show multiple perspective views of the quick-action fastening element.

An interior 1 of an oven, in which a latticed side part 4 is provided on opposing sides, is shown in FIG. 1. The latticed side part 4 extends from a front side 3 of the oven up to a rear side and has a plurality of horizontal rods 2. The horizontal rods 2 run from the front side 3 to a rear side and have an end section 5 which is bent over it essentially perpendicularly. The rods 2 are fixed on the angled end section 5 adjacent to a front side 14 on pillars 6 of the latticed side part 4.

A pullout guide 60 is installed on a horizontal rod 2, which comprises a rail 62, which is fixed via a quick-action fastening element 70 on a horizontal rod 2 (FIG. 2). A slide rail 61 of the pullout guide 60 comprises a contact surface for the placement of a cooking material carrier, a protruding bolt 13 being used as a stop and a cover cap 10 being provided toward the front side.

The quick-action fastening element 70 comprises a first clamp 71, which encloses a section of the rod 2 in a U shape in the longitudinal direction. Furthermore, a second clamp 76 is provided, which is also implemented as U-shaped in cross-section and encloses a bent-over end section 5.

Furthermore, a locking element 74, which is integrally formed with a wall section of the first clamp 71 and is formed by a protrusion, is provided for fixing the quick-action fastening element on the rod 2.

As shown in FIGS. 6 to 8, the protrusion 74 is formed on a strip-shaped section, which extends parallel to the longitudinal direction of the rod 2 and is spaced apart from the remaining part of the clamp 71 by a recess 75, which is implemented as U-shaped. A receptacle 15 for the rod 2 is formed between the protrusion and a floor section 73 of the clamp 71. The protrusion 74 is inclined to the horizontal, the highest point of the protrusion being situated adjacent to the rod 2. Due to the inclined implementation of the protrusion 74, it forms an insertion bevel, so that when the quick-action fastening element 70 is pushed onto the pullout guide 60, engagement occurs. The area between the protrusion 74 and an L-shaped section 72, which extends essentially up to the floor section 73, is used in each case as the lever distance. The floor section 73 is separated from the second clamp 76 via a recess 16, which is implemented as a slot, so that the two L-shaped sections 72 are elastically bendable.

A plate-shaped fastening section 78 is also provided adjacent to the first clamp 71, which is used for the optional lateral fixing on the pullout guide 60. The attachment of the quick-action fastening element 70 can thus be performed on the bottom or side of the pullout guide 60.

The second clamp 76 comprises a web 77, which encloses the bent-over end section 5. The second clamp 76 is implemented without locking element. However, it is possible to provide a locking element alternatively or additionally on the second clamp 76.

### LIST OF REFERENCE NUMERALS

1 interior
2 rod
3 front side
4 latticed side part
5 bent-over end section
6 pillar
10 cover cap
13 bolt
14 front side
15 receptacle
16 recess
60 pullout guide
61 slide rail
62 rail
70 quick-action fastening element
71 first clamp
72 L-shaped section
73 floor section
74 protrusion
75 recess
76 second clamp
77 web
78 fastening section

1. A quick-action fastening element (70) for fastening a rail (62) of a pullout guide (60) on a horizontal rod (2) of a latticed side part (4), in particular for ovens, the rod (2) having an end section (5) bent over at an angle to a longitudinal direction and the quick-action fastening element (70) having a first clamp (71), which at least partially encloses a section of the rod (2) situated in the longitudinal direction, and a second clamp (76), which at least partially encloses the bent-over end section (5), a locking element (74) being provided, which engages behind the rod (2) and prevents the quick-action fastening element (72) from being withdrawn in a direction parallel to the bent-over end section (5), characterized in that the locking element (74) is implemented as a rigid protrusion, which is integrally formed with the first or second clamp (71, 76).

2. The quick-action fastening element according to claim 1, characterized in that the protrusion of the locking element (74) is formed on a strip-shaped section and both sides of the strip-shaped section are connected to the clamps (71, 76).

3. The quick-action fastening element according to claim 1, characterized in that the locking element (74) is spaced apart from the remaining part of the clamps (71, 76), by a recess (75) enclosed on all sides by material of the clamps (71, 76).

4. The quick-action fastening element according to claim 3, characterized in that the recess (75) is implemented as U-shaped.

5. The quick-action fastening element according to claim 1, characterized in that the protrusion of the locking element (74) extends up to a middle area of the rod (2).

6. The quick-action fastening element according to claim 1, characterized in that the protrusion of the locking element (74) extends over the entire width of the locking element perpendicularly to the longitudinal direction of the rod (2) and is situated diagonally to the horizontal.

7. The quick-action fastening element according to claim 6, characterized in that the protrusion of the locking element (74) is largest adjacent to the rod (2).

8. The quick-action fastening element according to claim 1, characterized in that the locking element (74) is shaped on a wall section of the first clamp (71).

9. The quick-action fastening element according to claim 1, characterized in that the quick-action fastening element is produced in one piece from metal.
